(19) United States
(12) Patent Application Publication
(10) Pub. No.: US 2022/0269681 A1
(43) Pub. Date: Aug. 25, 2022

(54) COMPUTER-READABLE RECORDING MEDIUM STORING DATA SPECIFYING PROGRAM, DEVICE, AND METHOD

(71) Applicant: FUJITSU LIMITED, Kawasaki-shi (JP)

(72) Inventor: Shuya ABE, Kawasaki (JP)

(73) Assignee: FUJITSU LIMITED, Kawasaki-shi (JP)

(21) Appl. No.: 17/548,545

(22) Filed: Dec. 12, 2021

(30) Foreign Application Priority Data
Feb. 24, 2021 (JP) 2021-027418

(51) Int. Cl. G06F 16/2455

(52) U.S. Cl. CPC G06F 16/24564

(57) ABSTRACT

A non-transitory computer-readable recording medium stores a data specifying program for causing a computer to execute processing including: when receiving designation of first data included in second graph data generated by executing modification processing for first graph data that includes a plurality of data and information that indicates each relationship between the plurality of data, extracting one or a plurality of data from the first graph data on a basis of a character string of the first data; and specifying second data from the one or the plurality of data on a basis of a statistical result of modification content included in the modification processing.

### CROSS-REFERENCE TO RELATED APPLICATION

This application is based upon and claims the benefit of priority of the prior Japanese Patent Application No. 2021-27418, filed on Feb. 24, 2021, the entire contents of which are incorporated herein by reference.

### FIELD

The disclosed technology relates to a data specifying technology.

### BACKGROUND

Conventionally, there is a technology for analyzing data using graph data in which data is represented by nodes and the relationship between the data is represented by an edge. For example, in a SPARQL search query, a data analysis device that extracts variables of the SPARQL search query corresponding to frequently compared values has been proposed in order to associate data of a plurality of information sources. This device adds a new node created by combining the values corresponding to the extracted variables to RDF data, and searches for the newly added data at the time of a search.

International Publication Pamphlet No. WO 2014/207827 and Japanese Laid-open Patent Publication No. 2005-63332 are disclosed as related art.

### SUMMARY

According to an aspect of the embodiments, a non-transitory computer-readable recording medium stores a data specifying program for causing a computer to execute processing including: when receiving designation of first data included in second graph data generated by executing modification processing for first graph data that includes a plurality of data and information that indicates each relationship between the plurality of data, extracting one or a plurality of data from the first graph data on a basis of a character string of the first data; and specifying second data from the one or the plurality of data on a basis of a statistical result of modification content included in the modification processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an analysis using graph data;

FIG. 2 is a diagram illustrating an example of a screen displaying a plurality of analysis results in combination;

FIG. 3 is a diagram for describing a case of using analysis systems of different vendors;

FIG. 4 is a diagram for describing collation between subgraph data and original data;

FIG. 5 is a diagram for describing a problem of collation between subgraph data and original data;

FIG. 6 is a block diagram illustrating a schematic configuration of a medical data research support system;

FIG. 7 is a diagram illustrating an example of a medical data DB;

FIG. 8 is a diagram illustrating an example of an analysis result DB;

FIG. 9 is a functional block diagram of a data specifying device;

FIG. 10 is a diagram illustrating an example of analysis data;

FIG. 11 is a diagram illustrating an example of a statistical result DB;

FIG. 12 is a diagram for describing collation between analysis data and original data;

FIG. 13 is a diagram for describing collation between analysis data and original data;

FIG. 14 is a diagram illustrating an example of a score for each collation point;

FIG. 15 is a block diagram illustrating a schematic configuration of a computer that functions as the data specifying device;

FIG. 16 is a flowchart illustrating an example of pre-processing; and

FIG. 17 is a flowchart illustrating an example of collation processing.

### DESCRIPTION OF EMBODIMENTS

Furthermore, an information system associating device has been proposed that efficiently detects pairs of similar information elements between different information systems and supports data integration. This device analyzes statistical characteristics of the data of individual information elements belonging to each information system, and provides a common space for comparing a plurality of information systems on the basis of an analysis result. Then, this device detects, as an element pair, elements having similar statistical characteristics of the data of the information elements belonging to different information systems in space.

There may be a plurality of data present in original graph data, the plurality of data corresponding to certain data included in graph data generated by modifying the original graph data. In this case, there is a problem that the data corresponding to data selected from the graph data generated by modifying the original graph data may not be appropriately specified from the original graph data.

As one aspect, the disclosed technology aims to accurately specify, from original graph data, data corresponding to data selected from graph data generated by modifying the original graph data.

First, a reason for specifying, from original graph data, data corresponding to data selected from graph data generated by modifying the original graph data and a problem in specifying the data will be described.

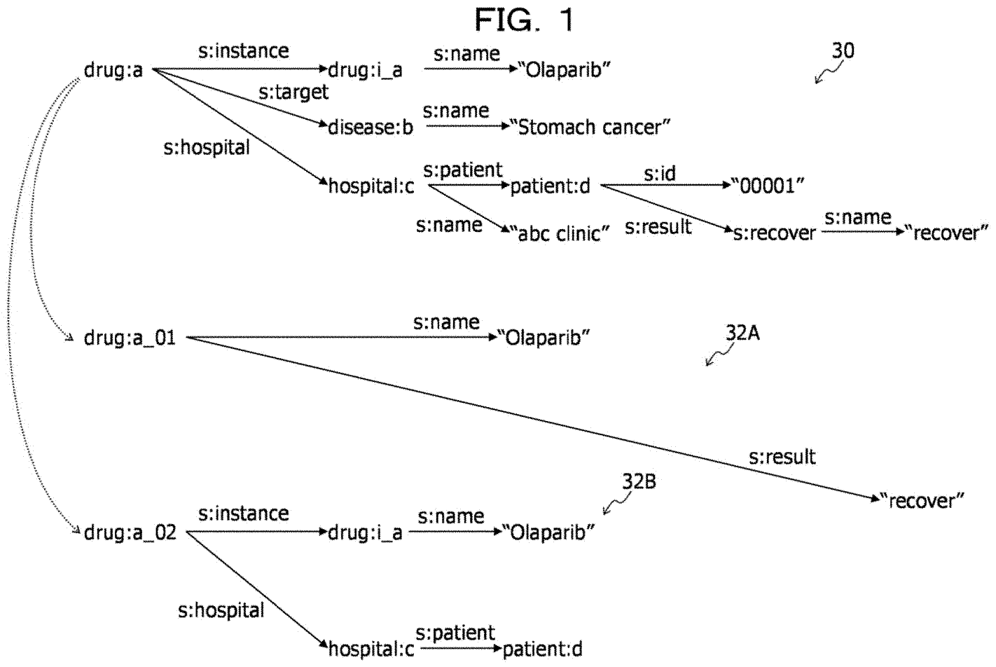

For example, assume a research support system that includes an analysis system that analyzes medical data and supports a research for drugs and diseases. As illustrated in FIG. 1, the medical data is stored in a database as graph data 30 such as resource description framework (RDF). Note that, in FIG. 1, a character string of a start point or an end point of a solid line arrow represents a node indicating data that is an instance, the arrow represents an edge indicating a relationship between data, and the character string written together with the edge represents content of the relationship. The same similarly applies to the other drawings below. Note that the graph data may include not only a node that is an instance but also a node that represents an ontology of data.

As illustrated in FIG. 1, the analysis system extracts subgraph data 32A and 32B needed for analysis from the original graph data 30, and processes the extracted subgraph data 32A and 32B into a format according to analysis content and use the processed subgraph data for the analysis. For example, the subgraph data 32A is subgraph data for inferring a drug effective for a specific disease to be researched in a case of researching a drug for the specific disease. Furthermore, the subgraph data 32B is subgraph data for aggregating the number of drug administrations for the disease to be researched.

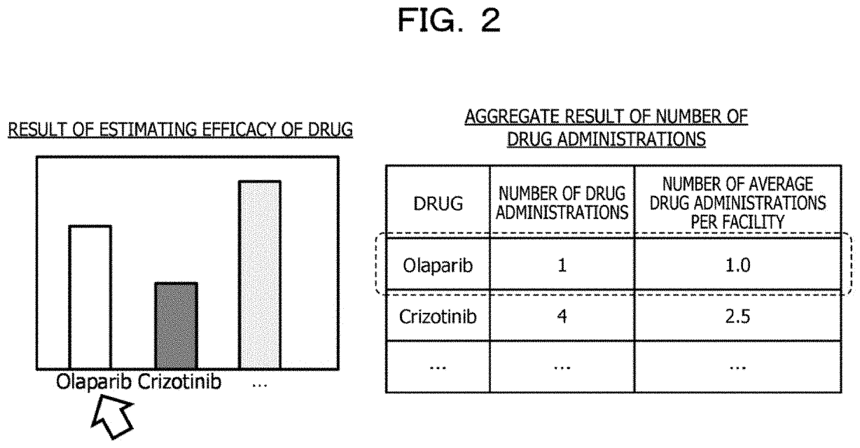

An analysis function of the research support system creates a screen for supporting a research by combining a plurality of analysis results, as illustrated in FIG. 2, using, for example, a plurality of analysis systems. A doctors or the like conducts a research while looking at this screen and selects an important element, and the research support system stores the selected element. In the case of conducting a research by combining a plurality of analysis results in this way, and in a case of selecting specific data of a certain analysis result, there may be a case of desiring to specify data corresponding to another analysis result. For example, as illustrated in FIG. 2, in a case of selecting a drug name “Olaparib” in a “result of estimating efficacy of drug”, there may be a case of highlighting data (the broken line part in FIG. 2) regarding “Olaparib” in an “aggregate result of the number of drug administrations”.

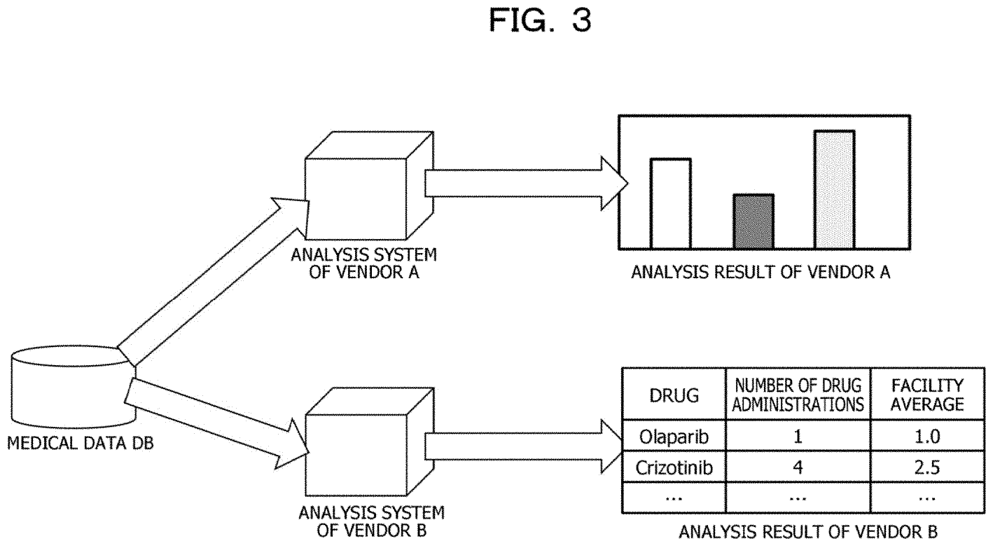

If the plurality of analysis systems can be manufactured in-house, information for associating analysis results can be added. Therefore, it is easy to specify corresponding data from another analysis result for the data selected from a certain analysis result. However, as illustrated in FIG. 3, in a case of using analysis systems from different vendors, the method of handling data differs for each analysis system due to a difference in specifications of the respective analysis systems. Therefore, it may be difficult to associate data between the different analysis systems due to reasons such as lack of information for associating the data between the different analysis systems. Therefore, in the embodiment to be described below, attention is paid to the fact that the original graph data used by the different analysis systems is the same, and data included in the original graph data corresponding to specific data included in an analysis result is specified.

As a method of specifying the data included in the original graph data, a computer acquiring subgraph data including a node of the data selected from the analysis result and a peripheral node of the node, and collating the acquired subgraph data with the original graph data is expected. Note that the peripheral node may be a node located at an internode distance from the node of the selected data that is within a predetermined value (for example, within four nodes). At the time of collation, the computer considers that the collation is successful in a case where a predetermined ratio or more of nodes included in the subgraph data match the original graph data. Then, the computer specifies data corresponding to the selected data from the original graph data for which the collation has been successful.

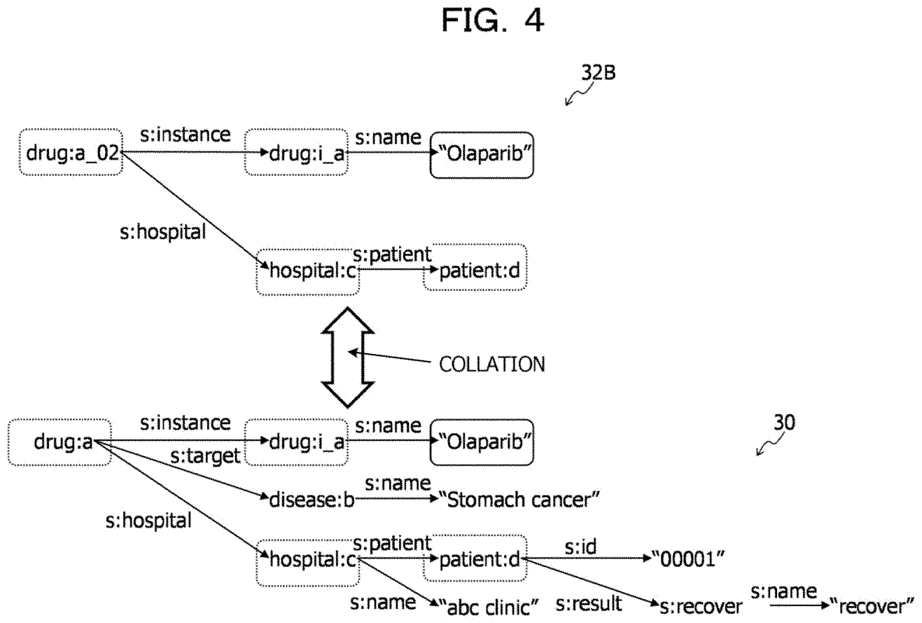

For example, in the case where the data “Olaparib” is selected from the analysis result, the computer acquires the subgraph data 32B of the analysis result including the node “Olaparib” and the peripheral node as illustrated in FIG. 4. The computer specifies a collation point in the original graph data 30 with respect to the subgraph data 32B of the analysis result, and determines correctness of the collation on the basis of the degree of coincidence of the nodes. In the example of FIG. 4, as illustrated by the node surrounded by the solid line or the broken line in FIG. 4, since nodes matching all the nodes included in the subgraph data 32B are present in the original graph data 30, the computer determines that the collation is successful. Then, the computer specifies the node “Olaparib” included in the part of the original graph data for which the collation has been successful as the data corresponding to the selected data.

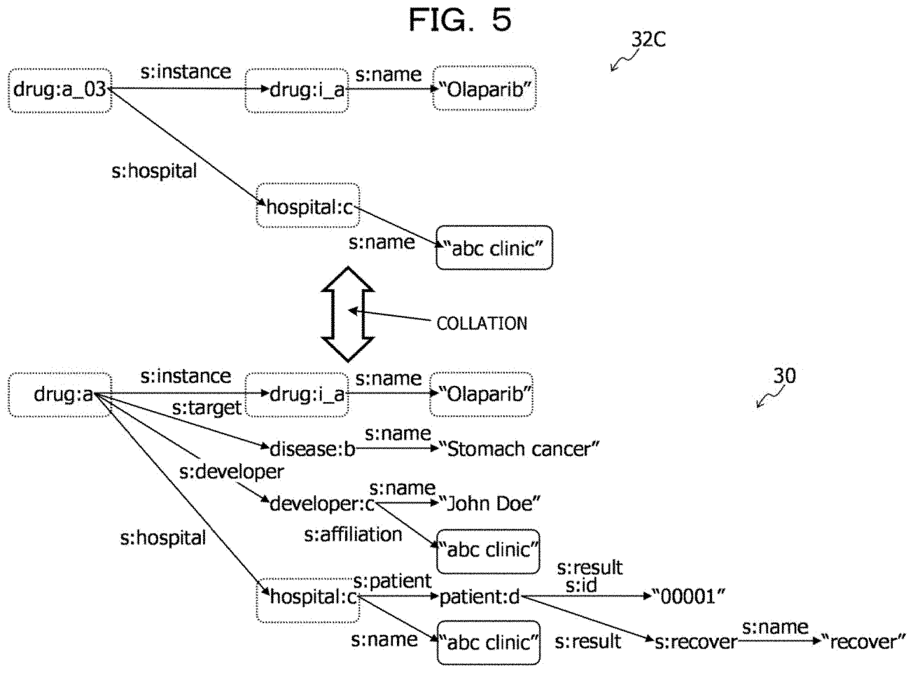

The problem here is that, as illustrated in FIG. 5, a plurality of data selected from the analysis result (“abc clinic” in the example of FIG. 5) is present in the original graph data 30, and a plurality of candidate collation points is present. In this case, it is conceivable to specify the data included in the collation point having a high degree of coincidence with respect to node included in the subgraph data 32C of the analysis result, as the data corresponding to the selected data. However, the graph data of the analysis result may be generated by being modified from the original graph data, and there is a possibility that nodes and edges have been added, deleted or the like. In that case, it may not be possible to properly specify the data corresponding to the selected data by simply looking at the degree of coincidence of the nodes. Therefore, in the present embodiment, the data corresponding to the data selected from the graph data of the analysis result is specified from the original graph data on the basis of a tendency of modification and statistical information in generating the graph data of the analysis result from the original graph data. Hereinafter, an example of an embodiment according to the disclosed technology will be described with reference to the drawings.

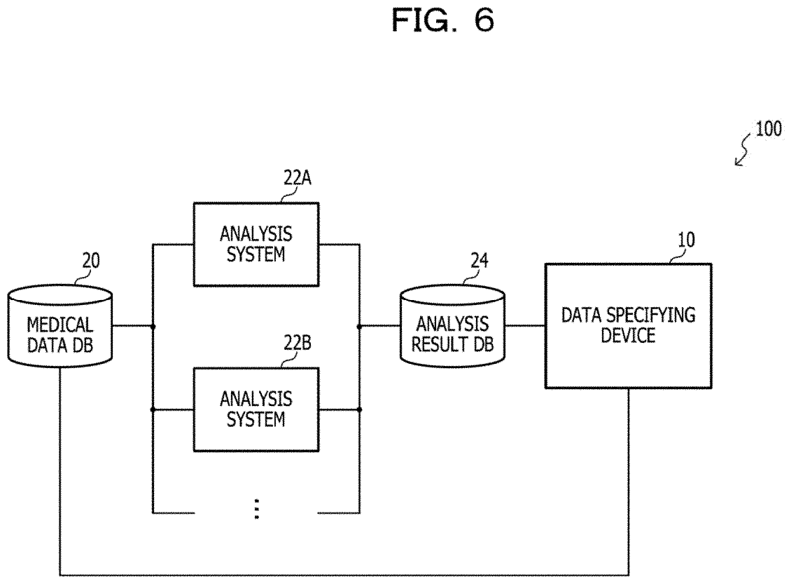

In the present embodiment, a data specifying device used in a medical data research support system will be described. As illustrated in FIG. 6, a medical data research support system 100 includes a medical data DB (database) 20, a plurality of analysis systems 22A, 22B, and the like, an analysis result DB 24, and a data specifying device 10. Hereinafter, in a case of describing the plurality of analysis systems 22A, 22B, and the like without distinguishing them, they are referred to as “analysis system(s) 22”, and in a case of describing the individual analysis systems 22, the analysis system 22A and the analysis system 22B are exemplified.

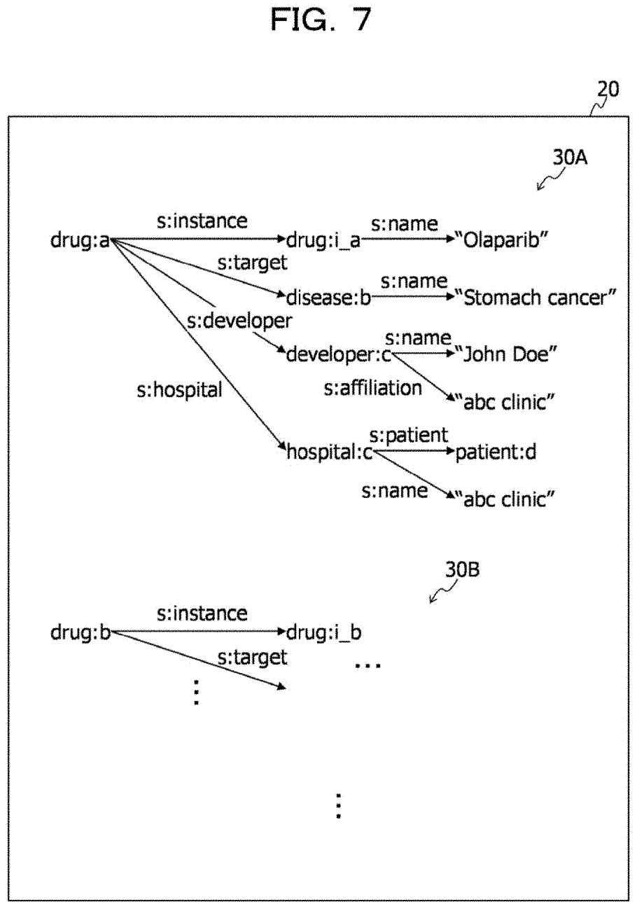

As illustrated in FIG. 7, the medical data DB 20 stores medical data represented by graph data including a node corresponding to each of a plurality of data and an edge representing each relationship between the plurality of data. The graph data may be in a format of RDF or the like. FIG. 7 illustrates an example of the graph data representing the medical data regarding a disease (disease-b) to be researched and drugs (drug-a, drug-b, and the like). Hereinafter, the graph data stored in the medical data DB20 will be referred to as the “original data”. The original data is an example of first graph data of the disclosed technology.

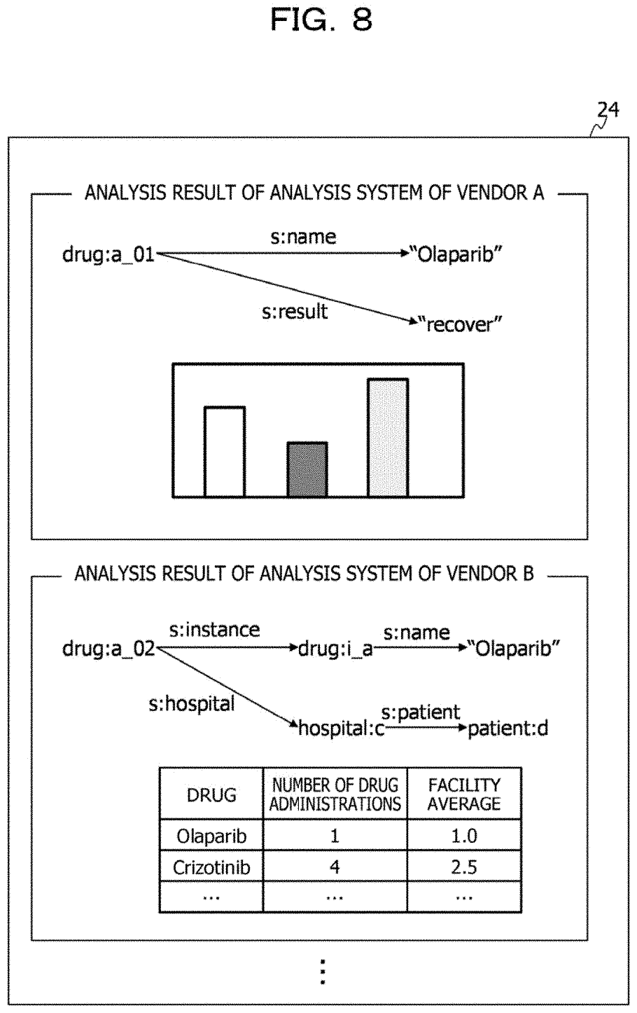

Each of the analysis systems 22 is a system that analyzes the original data and outputs an analysis result. Specifically, the analysis system 22 executes a modification processing for the original data to generate graph data for analysis, and executes an analysis such as extraction and aggregation of desired data on the basis of the graph data for analysis. The analysis system 22 stores the graph data for analysis and the analysis result in the analysis result DB 24, for example, as illustrated in FIG. 8. Note that FIG. 8 conceptually illustrates the graph data for analysis and the analysis result, and does not guarantee the consistency between the graph data for analysis and the analysis result. Furthermore, the analysis system 22A and the analysis system 22B are analysis systems respectively provided by different vendors. Hereinafter, the graph data for analysis generated by the analysis system 22 will be referred to as “analysis data”. The analysis data is an example of second graph data of the disclosed technology.

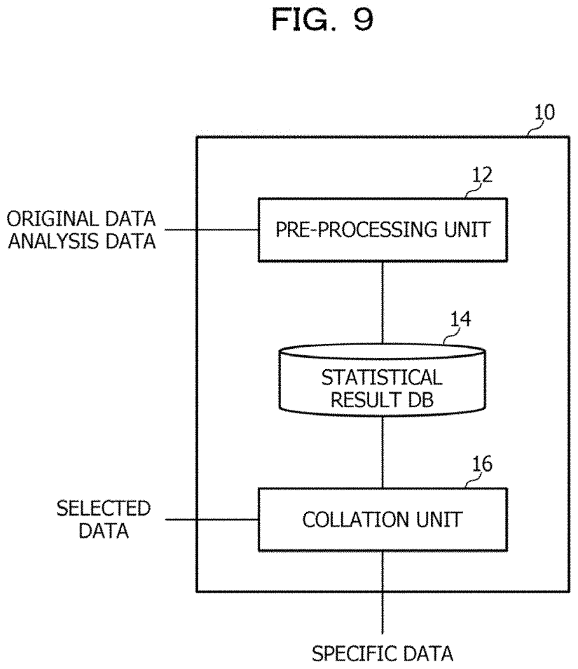

The data specifying device 10 specifies data in the original data, the data corresponding to the data selected from the analysis data. Functionally, the data specifying device 10 includes a pre-processing unit 12, a statistical result DB 14, and a collation unit 16, as illustrated in FIG. 9. The pre-processing unit 12 and the collation unit 16 are examples of a control unit of the disclosed technology.

The pre-processing unit 12 acquires tendency of modification processing when the original data is modified and the analysis data is generated on the basis of the original data and the analysis data. Specifically, the pre-processing unit 12 acquires a difference between a path having the highest degree of coincidence between the analysis data and the character string, in paths including one or more nodes connected by an edge included in the original data, and the analysis data, as the tendency of the modification processing. Note that the path is an example of a data string of the disclosed technology. More specifically, the pre-processing unit 12 sets a part including one edge, a node connected to a start point of the edge (hereinafter referred to as “start node”), and a node connected to an end point of the edge (hereinafter referred to as “end node”) in the graph data as a unit graph. The pre-processing unit 12 specifies the path of the original data before the modification of the unit graph on the basis of the character string of the unit graph for each unit graph included in the analysis data.

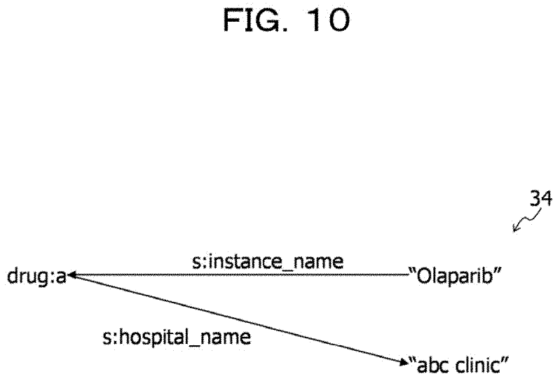

For example, it is assumed that the pre-processing unit 12 has acquired the original data 30A illustrated in FIG. 7 and analysis data 34 illustrated in FIG. 10. In this case, the pre-processing unit 12 extracts the following two unit graphs from the analysis data 34.

1: the start node “Olaparib”—the edge “s: instance_name”—the end node “drug:a”

2: the start node “drug:a”—the edge “s:hospital_name”—the end node “abc clinic”

Then, the pre-processing unit 12 extracts a path having a high degree of coincidence with respect to character string of each unit graph from the paths included in the original data. At this time, the pre-processing unit 12 searches for a path in consideration of the possibility that nodes and edges are deleted or added, edges are omitted, edges are inverted, or the like in the modification processing. For example, the pre-processing unit 12 may determine the degree of coincidence between a character string obtained by combining the character strings of a plurality of consecutive edges of the original data and the character string of the edge of the unit graph. In the case of the unit graph 1 above, the edge “s:instance” and the edge “s:name” are present between the nodes of the original data 30A, the nodes having character strings matching the character strings of the start node and the end node. In this case, the pre-processing unit 12 may determine that the degree of coincidence between the character string obtained by combining the character strings of both the edges and the edge “s:instance_name” of the unit graph is high.

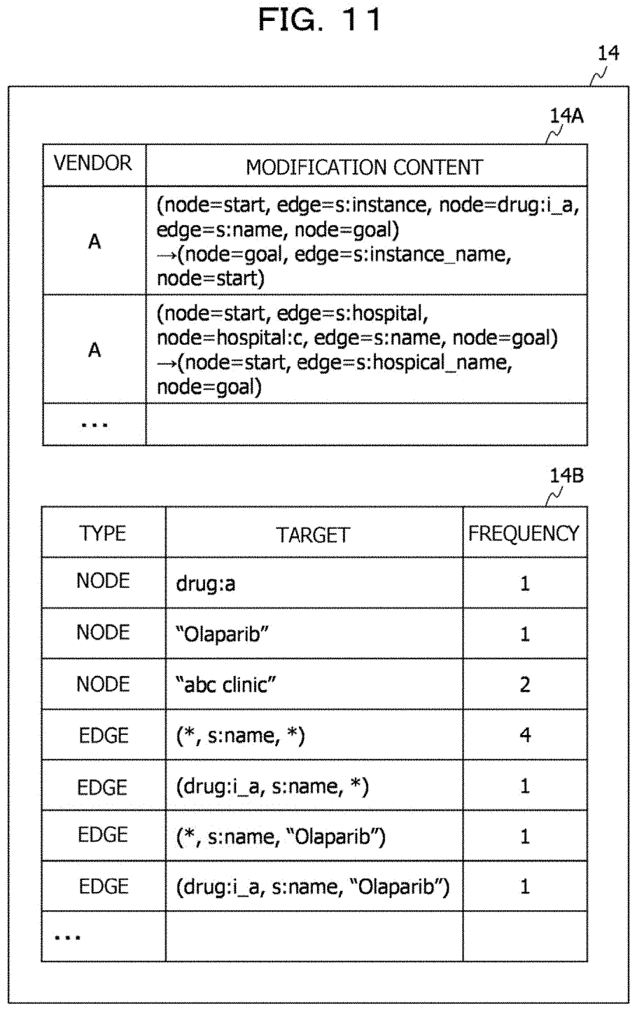

The pre-processing unit 12 associates and stores the unit graph and the extracted path as “modification content” in a modification tendency table 14A of the statistical result DB 14 as illustrated in FIG. 11, for example. At this time, the pre-processing unit 12 generalizes each of the start nodes and the end nodes of the unit graph and the extracted path by, for example, replacing the character strings of the start nodes with “start” and the character strings of the end nodes with “goal”. Note that, in the example of FIG. 11, the modification tendency table 14A stores information of which vendor's analysis data of the analysis system 22 has been used (“vendor” in FIG. 11) and the modification content in association with each other. This modification content is information indicating that there is a tendency of omission of edges, a tendency of addition or deletion of nodes or edges, a tendency of inversion of edges, or the like, in the modification processing.

Furthermore, the pre-processing unit 12 aggregates the frequency of appearance in the original data, of each of the nodes and edges included in the original data. The pre-processing unit 12 stores the aggregated frequency in a frequency table 14B of the statistical result DB14 as illustrated in FIG. 11, for example. In the example of FIG. 11, the frequency table 14B stores a “type” indicating whether a target is a node or an edge, the “target”, and the “frequency” of the target. Furthermore, in the example of FIG. 11, the pre-processing unit 12 aggregates the frequency of the edge for each combination (start node, edge, and end node) of the start node and the end node connected to the edge. Specifically, the pre-processing unit 12 aggregates four patterns including a case where the start node and the end node are arbitrary (“*” in FIG. 11), a case where the start node is limited and the end node is arbitrary, a case where the start node is arbitrary and the end node is limited, and a case where the start node and the end node are limited.

When receiving designation of data (hereinafter referred to as “selected data”) selected from the data included in the analysis data, the collation unit 16 extracts one or a plurality of data from the original data on the basis of the character string of the selected data. The selected data is an example of first data of the disclosed technology. The collation unit 16 specifies data (hereinafter referred to as “specific data”) corresponding to the selected data from the one or plurality of data on the basis of statistical result stored in the statistical result DB 14. The specific data is an example of second data of the disclosed technology.

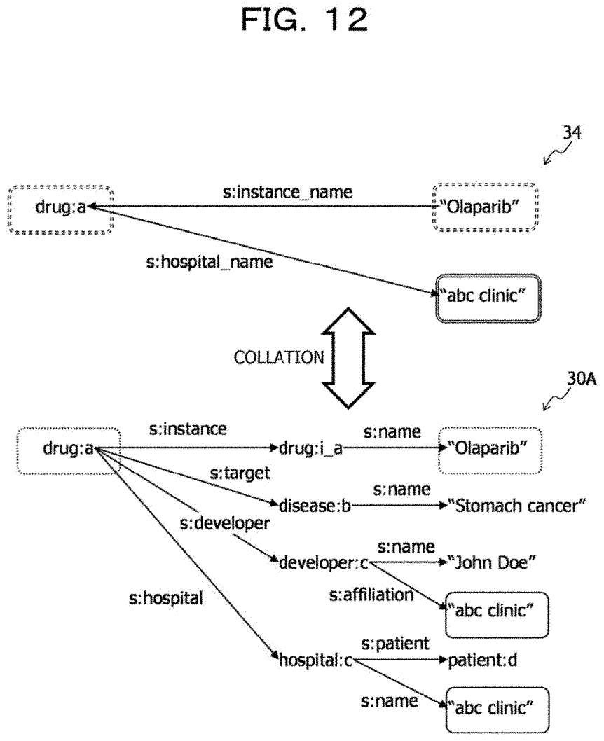

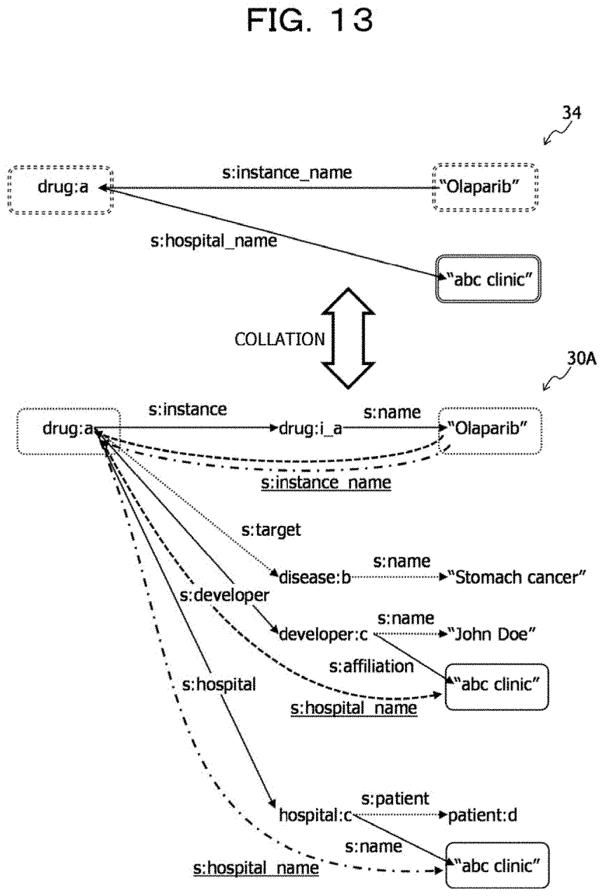

Specifically, the collation unit 16 specifies a collation point with respect to the analysis data from the original data on the basis of the character string of each node of the analysis data including the selected data. The collation point is an example of a part of the first graph data corresponding to the second graph data of the disclosed technology. For example, assume that the node “abc clinic” (the node surrounded by the double line in FIG. 12) is selected as the selected data from the analysis data 34 as illustrated in the upper figure of FIG. 12. In this case, the collation unit 16 extracts the nodes (the nodes surrounded by the solid line in FIG. 12) having the character string matching the character string “abc clinic” from the original data 30A as illustrated in the lower figure of FIG. 12. Furthermore, the collation unit 16 extracts the node (the node surrounded by the dotted line in FIG. 12) having the character string matching another node (the node surrounded by the double dotted line in FIG. 12) included in the analysis data 34 from the original data 30A. Note that the match of the character strings is not limited to perfect match and a case where the degree of coincidence is equal to or higher than a predetermined value may also be determined to match. Then, as illustrated in FIG. 13, the collation unit 16 specifies a path tracing the nodes of the original data 30A extracted corresponding to the respective nodes of the analysis data 34 in the order of an edge direction of the analysis data 34, as the collation point with respect to the analysis data 34. In the example of FIG. 13, two collation points indicated by the broken line arrow and indicated by the one-dot chain line arrow are specified.

The collation unit 16 calculates a score based on the statistical result for each collation point, and specifies data corresponding to the selected data included in the collation point and selected on the basis of the score as specific data. The score based on the statistical result may be a score based on the frequency with which each of the nodes and edges included in the analysis data 34 appears in the original data 30A. The collation unit 16 refers to the frequency table 14B stored in the statistical result DB 14 and acquires the frequency of each of the nodes and edges included in the analysis data 34. Note that, in the present embodiment, regarding the frequency of edges, four patterns are aggregated by pre-processing depending on whether the nodes at both ends are limited or arbitrary. Therefore, the collation unit 16 uses the frequency of the pattern having the highest degree of coincidence with respect to edge of the analysis data 34 among the four patterns. That is, in a case where the pattern with a more limited start node or end node matches the edge of the analysis data 34, the collation unit 16 uses the frequency of the pattern. Note that, in the example of FIG. 11, the pattern has a more limited start node or end node from the top to the bottom for the rows of the type “edge”.

The score based on the frequency is a value indicating that the lower the acquired frequency, the higher the degree of coincidence between the analysis data 34 and the collation point. This is because in the case where the frequency is low, there is a high possibility that the analysis data and the collation point match. The collation unit 16 calculates a value obtained by multiplying a reciprocal of the acquired frequency by a coefficient a as the score based on the frequency, for example. Note that, in a case where a matching target among the nodes and edges included in the analysis data 34 is not stored in the frequency table 14B, the score based on the frequency of the node or the edge is 0.

Furthermore, the score based on the statistical result may be a score based on an internode distance represented by the number of data between nodes included in the collation point and corresponding to the nodes included in the analysis data 34. The score based on the internode distance is a value indicating that the larger the number of data between the nodes, the lower the degree of coincidence between the analysis data 34 and the collation point. This is because nodes having the internode distance in the original data are rarely included in the same analysis data 34, and the possibility that the analysis data and the collation point match is low. For example, the collation unit 16 multiplies values each obtained by dividing the distance to another node (the number of nodes in the distance) by a coefficient γ of all the nodes included in the collation point and corresponding to the nodes included in the analysis data 34, as the score based on the internode distance. For example, in the example of FIG. 13, regarding the node “Olaparib”, the distance to the node “drug:a” is 1, and the distance to the node “abc clinic” is 3. In this case, the collation unit 16 calculates the score based on the internode distance for the node “Olaparib” as 1/γ×3/γ.

Furthermore, the score based on the statistical result may be a score (hereinafter referred to as a “score based on modification tendency”) based on the degree of match between the difference between the collation point and the analysis data 34 and the tendency of the modification processing acquired in advance. The score based on modification tendency is a value indicating that the higher the degree of match with respect to tendency of the modification processing, the higher the degree of coincidence between the analysis data 34 and the collation point. For example, in a case where a combination of the unit graph of the analysis data 34 and the corresponding path of the collation point is present in the modification tendency table 14A of the statistical result DB14, the collation unit 16 gives a constant β to a part corresponding to an appropriate edge of the collation point, as the score based on the modification tendency. For example, in the example of FIG. 13, at the collation point illustrated by the broken line, modification content of the combination of the path corresponding to the unit graph including the edge “s:hospital_name” of the analysis data 34 and the unit graph of the analysis data 34 is not present in the modification tendency table 14A. Therefore, the collation unit 16 does not give β to the part corresponding to the edge “s:hospital_name” of the collation point indicated by the broken line. Furthermore, in the example of FIG. 13, at the collation point illustrated by the one-dot chain line, modification content of the combination of the path corresponding to the unit graph including the edge “s:hospital_name” of the analysis data 34 and the unit graph of the analysis data 34 is present in the modification tendency table 14A. Therefore, the collation unit 16 gives β to the part corresponding to the edge “s:hospital_name” of the collation point indicated by the one-dot chain line.

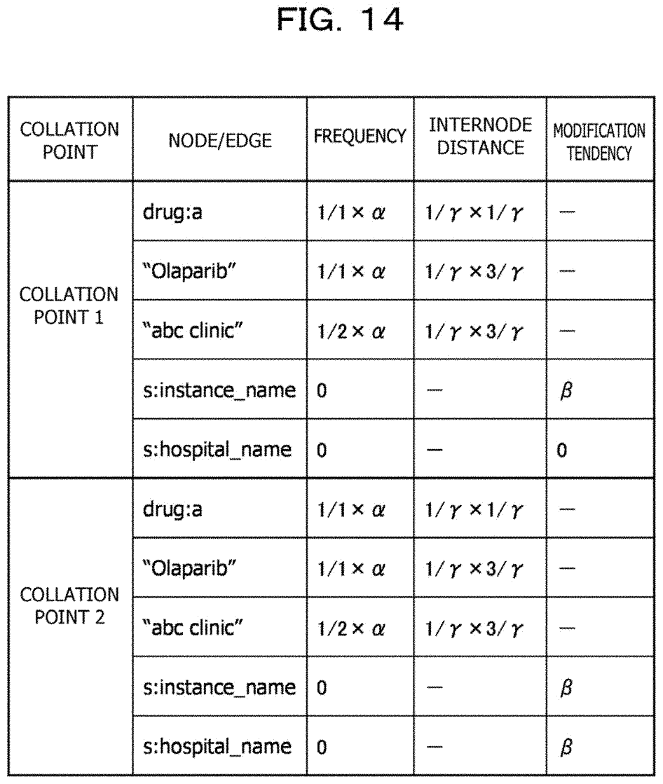

FIG. 14 illustrates an example of each score calculated for the part corresponding to each of the nodes and edges of the analysis data 34, for each collation point. In FIG. 14, the collation point 1 corresponds to the collation point illustrated by the broken line in FIG. 13, and the collation point 2 corresponds to the collation point illustrated by the one-dot chain line in FIG. 13. Furthermore, in FIG. 14, “frequency” is the score based on the frequency, “internode distance” is the score based on the internode distance, and “modification tendency” is the score based on the modification tendency. The collation unit 16 calculates an integrated score integrated by, for example, adding up each of the scores calculated for each of the nodes and edges, for each collation point. Note that, for α, β, and γ, arbitrary values such as α=1, β=1.1, and γ=0.5 may be set. The collation unit 16 specifies the collation point having the highest integrated score, and specifies the node corresponding to the selected node among the nodes included in the specified collation point, specifically, the node having the character string matching the character string of the selected node, as the specific node. The collation unit 16 outputs information of the specified specific node as a collation result.

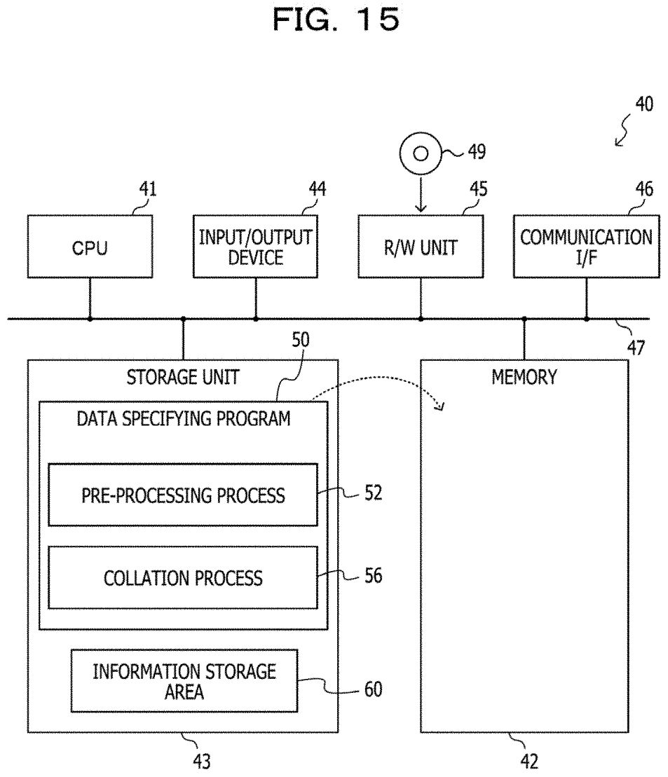

The data specifying device 10 can be implemented by, for example, a computer 40 illustrated in FIG. 15. The computer 40 includes a central processing unit (CPU) 41, a memory 42 as a temporary storage area, and a nonvolatile storage unit 43. Furthermore, the computer 40 includes an input/output device 44 such as an input unit and a display unit, and a read/write (R/W) unit 45 that controls reading and writing of data from/to a storage medium 49. Furthermore, the computer 40 includes a communication interface (I/F) 46 to be connected to a network such as the Internet. The CPU 41, the memory 42, the storage unit 43, the input/output device 44, the R/W unit 45, and the communication I/F 46 are connected to one another via a bus 47.

The storage unit 43 may be implemented by a hard disk drive (HDD), a solid state drive (SSD), a flash memory, or the like. The storage unit 43 as a storage medium stores a data specifying program 50 for causing the computer 40 to function as the data specifying device 10. The data specifying program 50 has a pre-processing process 52 and a collation process 56. Furthermore, the storage unit 43 has an information storage area 60 in which information constituting the statistical result DB 14 is stored.

The CPU 41 reads out the data specifying program 50 from the storage unit 43 and expands the data specifying program 50 in the memory 42 and sequentially executes the processes included in the data specifying program 50. The CPU 41 operates as the pre-processing unit 12 illustrated in FIG. 9 by executing the pre-processing process 52. Furthermore, the CPU 41 operates as the collation unit 16 illustrated in FIG. 9 by executing the collation process 56. Furthermore, the CPU 41 reads information from the information storage area 60 and expands the statistical result DB 14 to the memory 42. With these procedures, the computer 40 executing the data specifying program 50 functions as the data specifying device 10. Note that the CPU 41 that executes programs is hardware.

Note that functions implemented by the data specifying program 50 can also be implemented by, for example, a semiconductor integrated circuit, in more detail, an application specific integrated circuit (ASIC) or the like.

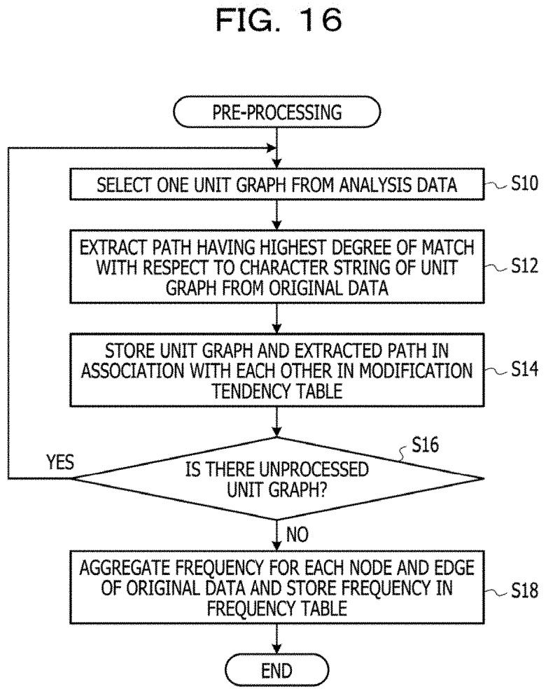

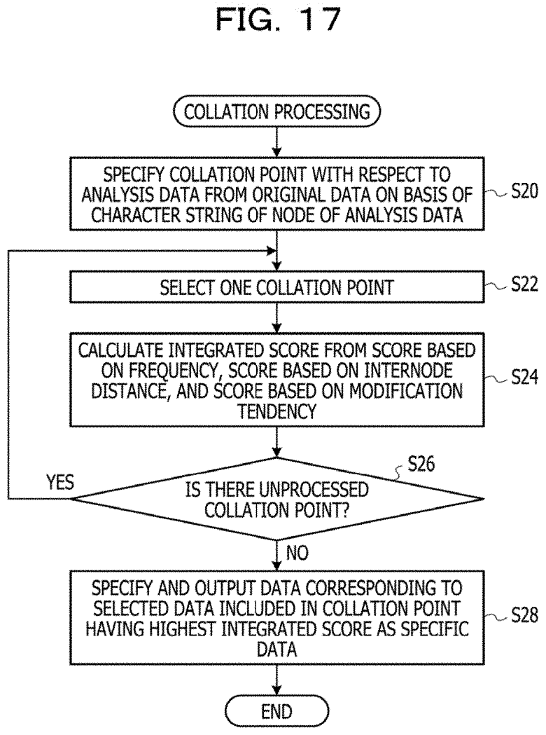

Next, the operation of the data specifying device 10 according to the present embodiment will be described. When the analysis result by any of the analysis systems 22 is stored in the analysis result DB 24, the data specifying device 10 executes pre-processing illustrated in FIG. 16. Furthermore, when the data specifying device 10 receives the selected data, the data specifying device 10 executes collation processing illustrated in FIG. 17. Note that the pre-processing and collation processing are examples of a data specifying method of the disclosed technology. Hereinafter, each of the pre-processing and the collation processing will be described in detail.

First, the pre-processing illustrated in FIG. 16 will be described. In step S10, the pre-processing unit 12 selects one unit graph including one edge, the start node, and the end node from the analysis data 34 including the node illustrating the selected data. Next, in step S12, the pre-processing unit 12 extracts the path having the highest degree of coincidence of the character string of the node and the edge of the path with the character string of the node and the edge included in the selected unit graph, among the paths included in the original data 30A. Next, in step S14, the pre-processing unit 12 stores the unit graph selected in step S10 described above and the path extracted in step S12 described above in association with each other as “modification content” in the modification tendency table 14A of the statistical result DB14.

Next, in step S16, the pre-processing unit 12 determines whether a unit graph for which the processing of steps S12 and S14 described above has not been processed is present in the analysis data 34. In the case where the unprocessed unit graph is present, the processing returns to step S10, or in the case where the processing has been completed for all the unit graphs, the processing proceeds to step S18. In step S18, the pre-processing unit 12 aggregates the frequency of appearance in the original data 30A, of each of the nodes and edges included in the original data 30A, and stores the aggregated frequency in the frequency table 14B of the statistical result DB14. Then, the pre-processing is terminated.

Next, the collation processing illustrated in FIG. 17 will be described. In step S20, the collation unit 16 extracts the nodes having a character string matching the nodes included in the analysis data 34 from the original data 30A. Then, the collation unit 16 specifies the path tracing the nodes of the original data 30A extracted corresponding to the respective nodes of the analysis data 34 in the order of an edge direction of the analysis data 34, as the collation point with respect to the analysis data 34. Next, in step S22, the collation unit 16 selects one collation point from the collation points specified in step S20 described above. Next, in step S24, the collation unit 16 calculates, for the selected collation point, a score based on the frequency, a score based on the internode distance, and a score based on the modification tendency and integrates each of the scores to calculate an integrated score.

Next, in step S26, the collation unit 16 determines whether there is a collation point that has not been processed in step S24 described above among the collation portions specified in step S20 described above. In the case where there is an unprocessed collation point, the processing returns to step S22, or in the case where all the collation points have been processed, the processing proceeds to step S28. In step S28, the collation unit 16 specifies the collation point having the highest integrated score, specifies the node corresponding to the selected node as the specific node among the nodes included in the specified collation point, and outputs the specific node as the collation result. Then, the collation processing is terminated.

As described above, the data specifying device according to the present embodiment receives designation of the selected data included in the graph data for analysis generated by executing the modification processing for the original graph data. The graph data includes a plurality of nodes indicating each of the plurality of data, and an edge connecting the nodes on the basis of the respective relationships between the plurality of data. Then, the data specifying device extracts one or a plurality of collation points for being collated with the graph data for analysis from the original graph data on the basis of the character string of the graph data for analysis including the selected data. Then, the data specifying device specifies the second data from the collation point on the basis of the statistical result of the modification content included in the modification processing from the original graph data to the graph data for analysis. Thereby, even in the case where a plurality of data corresponding to the selected data is included in the original graph data, the data specifying device can accurately specify, from the original graph data, the data corresponding to the data selected from the graph data generated by modifying the original graph data.

Furthermore, similar processing to the above-described collation processing can be executed using the original data in which the specific data has been specified and analysis data generated by another analysis system, and data corresponding to the specific data can be specified from among data included in the another analysis data. Thereby, corresponding data can be specified between analysis results by the respective analysis systems of different vendors.

Note that, in the above-described embodiment, the case of calculating the integrated score for each collation point by integrating all the score based on the frequency, the score based on the internode distance, and the score based on the modification tendency has been described. However, the embodiment is not limited to the case. It is sufficient to use at least one of the score based on the frequency, the score based on the internode distance, or the score based on the modification tendency.

Furthermore, in the above-described embodiment, the score based on the internode distance uses the number of nodes between nodes in the original data (collation point). However, the embodiment is not limited to the case. For example, in a case where the modification content in the modification processing acquired in the pre-processing indicate that the edges are likely to be omitted, there is a possibility that the analysis data and the collation point match even if the internode distance is long. In such a case, the score based on the internode distance may be calculated using the number of nodes between nodes of the collated analysis data.

Furthermore, in the above embodiment, the case where the target data is medical data has been described as an example. However, the disclosed technology can be applied to data as long as the data is represented as graph data.

Furthermore, in the above-described embodiment, a mode in which the data specifying program is stored (installed) in the storage unit in advance has been described, but the embodiment is not limited thereto. The program according to the disclosed technology may also be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data specifying program for causing a computer to execute processing comprising:
when receiving designation of first data included in second graph data generated by executing modification processing for first graph data that includes a plurality of data and information that indicates each relationship between the plurality of data, extracting one or a plurality of data from the first graph data on a basis of a character string of the first data; and
specifying second data from the one or the plurality of data on a basis of a statistical result of modification content included in the modification processing.

2. The non-transitory computer-readable recording medium storing a data specifying program according to claim 1, wherein
the processing of specifying the second data includes calculating a score based on the statistical result for each part of the first graph data that corresponds to the second graph data, the part that is extracted on the basis of the character string of the first data, and specifying data that corresponds to the first data included in the part of the first graph data specified on a basis of the score as the second data.

3. The non-transitory computer-readable recording medium storing a data specifying program according to claim 2, wherein
the score based on the statistical result is a score based on at least one of
a frequency with which each of data and a relationship included in the second graph data appears in the first graph data,
the number of data between data included in the part of the first graph data that corresponds to data included in the second graph data, or
a degree of match between a difference between the part of the first graph data and the second graph data, and a tendency of the modification processing acquired in advance.

4. The non-transitory computer-readable recording medium storing a data specifying program according to claim 3, wherein
the score indicates that the degree of coincidence between the second graph data and the part of the first graph data is higher as the frequency is lower.

5. The non-transitory computer-readable recording medium storing a data specifying program according to claim 3, wherein
the score indicates that the degree of coincidence between the second graph data and the part of the first graph data is lower as the number of data is larger.

6. The non-transitory computer-readable recording medium storing a data specifying program according to claim 3, wherein
the score indicates that the degree of coincidence between the second graph data and the part of the first graph data is higher as the degree of match with respect to tendency of the modification processing is higher.

7. The non-transitory computer-readable recording medium storing a data specifying program according to claim 3, for causing the computer to execute the processing further comprising:
acquiring at least one of the frequency or the tendency of the modification processing on a basis of the first graph data and the second graph data.

8. The non-transitory computer-readable recording medium storing a data specifying program according to claim 7, wherein
the processing of acquiring the tendency of the modification processing includes acquiring a difference between a data string that has a highest degree of coincidence of a character string with the second graph data, and the second graph data, among data strings that include one or more data connected by the relationship included in the first graph data.

9. An information processing device comprising:
a memory; and
a processor coupled to the memory and configured to:
when receiving designation of first data included in second graph data generated by executing modification processing for first graph data that includes a plurality of data and information that indicates each relationship between the plurality of data, extract one or a plurality of data from the first graph data on a basis of a character string of the first data; and
specify second data from the one or the plurality of data on a basis of a statistical result of modification content included in the modification processing.

10. The information processing device according to claim 9, wherein
the processor calculates a score based on the statistical result for each part of the first graph data that corresponds to the second graph data, the part that is extracted on the basis of the character string of the first data, and specifies data that corresponds to the first data included in the part of the first graph data specified on a basis of the score as the second data.

11. The information processing device according to claim 10, wherein
the score based on the statistical result is a score based on at least one of
a frequency with which each of data and a relationship included in the second graph data appears in the first graph data,
the number of data between data included in the part of the first graph data that corresponds to data included in the second graph data, or
a degree of match between a difference between the part of the first graph data and the second graph data, and a tendency of the modification processing acquired in advance.

12. The information processing device according to claim 11, wherein
the score indicates that the degree of coincidence between the second graph data and the part of the first graph data is higher as the frequency is lower.

13. The information processing device according to claim 11, wherein
the score indicates that the degree of coincidence between the second graph data and the part of the first graph data is lower as the number of data is larger.

14. The information processing device according to claim 11, wherein
the score indicates that the degree of coincidence between the second graph data and the part of the first graph data is higher as the degree of match with respect to tendency of the modification processing is higher.

15. The information processing device according to claim 11, wherein
the processor acquires at least one of the frequency or the tendency of the modification processing on a basis of the first graph data and the second graph data.

16. The information processing device according to claim 15, wherein
the processor acquires a difference between a data string that has a highest degree of coincidence of a character string with the second graph data, and the second graph data, among data strings that include one or more data connected by the relationship included in the first graph data.

17. A data specifying method comprising:
when receiving designation of first data included in second graph data generated by executing modification processing for first graph data that includes a plurality of data and information that indicates each relationship between the plurality of data, extracting, by a computer, one or a plurality of data from the first graph data on a basis of a character string of the first data; and
specifying second data from the one or the plurality of data on a basis of a statistical result of modification content included in the modification processing.

18. The data specifying method according to claim 17, wherein
the processing of specifying the second data includes calculating a score based on the statistical result for each part of the first graph data that corresponds to the second graph data, the part that is extracted on the basis of the character string of the first data, and specifying data that corresponds to the first data included in the part of the first graph data specified on a basis of the score as the second data.

19. The data specifying method according to claim 18, wherein
the score based on the statistical result is a score based on at least one of
a frequency with which each of data and a relationship included in the second graph data appears in the first graph data,
the number of data between data included in the part of the first graph data that corresponds to data included in the second graph data, or
a degree of match between a difference between the part of the first graph data and the second graph data, and a tendency of the modification processing acquired in advance.
